(19) United States
(12) Patent Application Publication
(10) Pub. No.: US 2008/0053569 A1
(43) Pub. Date: Mar. 6, 2008

(54) Automatic pencil sharpener

(76) Inventor: Joseph Y. Ko, Laguna Niguel, CA (US)

Correspondence Address: BIRCH STEWART KOLASCH & BIRCH, PO BOX 747, FALLS CHURCH, VA, 22040-0747, US

(21) Appl. No.: 11/514,844

(22) Filed: Sep. 5, 2006

(51) Int. Cl. B43L 23/00

(52) U.S. Cl. 144/28.72

(57) ABSTRACT

The present invention discloses an automatic pencil sharpener that includes a box, a rack at the rear in the box, a driving source at the front of the rack, and a retarded gear set for driving a rolling blade to rotate, and the rolling blade is installed in a chamber, and the front of the box has pencil insert holes of different diameters. The rear at the middle of the insert hole has a trigger, such that if a pencil is inserted, the trigger sends a signal to the driving source to start sharpening the pencil. After the pencil is sharpened, a detecting apparatus in the insert hole sends a signal to the driving source to stop sharpening the pencil and indicate that the pencil is sharpened, so as to provide the function of sharpening a pencil automatically.

### FIELD OF THE INVENTION

The present invention relates to a pencil sharpener, and more particularly to an electric pencil sharpener capable of starting a rolling blade to sharpen a pencil with an automatic detection and stopping its operation after the pencil is sharpened.

### BACKGROUND OF THE INVENTION

In a traditional electric pencil sharpener disclosed in R.O.C. Patent No. M281802, the electric pencil sharpener as illustrated in FIGS. 1 to 3 of its patent specification includes a casing, a pencil hole a2 disposed at the front of the casing, a blade portion a1 disposed transversally in the middle of the casing driven by an electric motor to rotate and constitute an angle with respect to the center line of the blade portion a1 and the pencil hole a2, a fine-tune switch a3 installed in the pencil hole a2 for pushing a slide member a4 to touch a pencil b, so as to achieve the purpose of controlling the ON/OFF state of the pencil sharpener, and a slide member a4 for covering half of the pencil hole a2 as shown in FIG. 2.

When the traditional pencil sharpener is used, a pencil b is inserted into the pencil hole a2, and the tip of the pencil b is pressed by the pushing force of the slide member a4 to release the fine-tune switch a3 after the slide member a4 is rotated towards a side. In FIG. 3 of the patent specification, the electric motor is started to rotate the blade portion a1 according to a predetermined angle to shave a tip of the pencil b into a lead core with an appropriate cone angle. However, the pencils b available in the market come with different diameters, and a pencil whose diameter is too small cannot be able to be inserted into the pencil hole a2, and a pencil whose diameter is too large will be shaken after being inserted into the pencil hole a2. Therefore, pencil sharpeners sold in the market include those having a rotary cover a5 with different sizes of pencil holes, and the rotary cover a5 can be rotated to change the size of the pencil hole a2 of the corresponding blade portion a1, but the slide member a4 keeps touching the surface of the pencil b continuously, and its contact area is too large and the resistance is increased, such that the pencil b cannot be inserted into or removed from the pencil hole a2 smoothly.

### SUMMARY OF THE INVENTION

The primary objective of the present invention is to provide an automatic pencil sharpener comprising: a box; a rack disposed at the rear side in the box; a driving source disposed at the front side of the box and driven by a gear set for driving a rolling blade to rotate, and the rolling blade is disposed in a chamber; a window disposed at the front of the box; a fixing plate disposed at the rear of the window; a circular fixed pencil insert hole disposed at the middle of the fixing plate; a slide member disposed separately on both left and right sides of the insert hole and being moved to the left side or the right side and having an insert hole with a different diameter, and a trigger installed to the fixed insert hole. If a pencil is inserted, the trigger sends a signal to the driving source to start sharpening the pencil. After the pencil is sharpened, a detecting apparatus in the insert hole sends a signal to the driving source to stop the operation and indicate that the pencil is sharpened. The invention provides a way of sharpening pencils of different diameters stably and a function of automatically turning on/off the pencil sharpener.

Another objective of the present invention is to provide an automatic pencil sharpener, wherein the box has a letter opening mechanism disposed at the rear of the box, such that two circular blades in the box provide the function of opening letters.

### BRIEF DESCRIPTION OF THE DRAWINGS

FIG. 1 is an exploded view of a preferred embodiment of the present invention;

FIG. 2 is a perspective view of a preferred embodiment of the present invention;

FIG. 3 is a longitudinal cross-sectional view of a preferred embodiment of the present invention;

FIG. 4A is a schematic view of detailed movements in accordance to a preferred embodiment of the present invention;

FIG. 4B is another schematic view of detailed movements in accordance to a preferred embodiment of the present invention;

FIG. 5A is a planar view of a preferred embodiment of the present invention;

FIG. 5B is a schematic view of movements in accordance with a preferred embodiment of the present invention; and

FIG. 6 is a schematic view of a letter opening mechanism in accordance with a preferred embodiment of the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

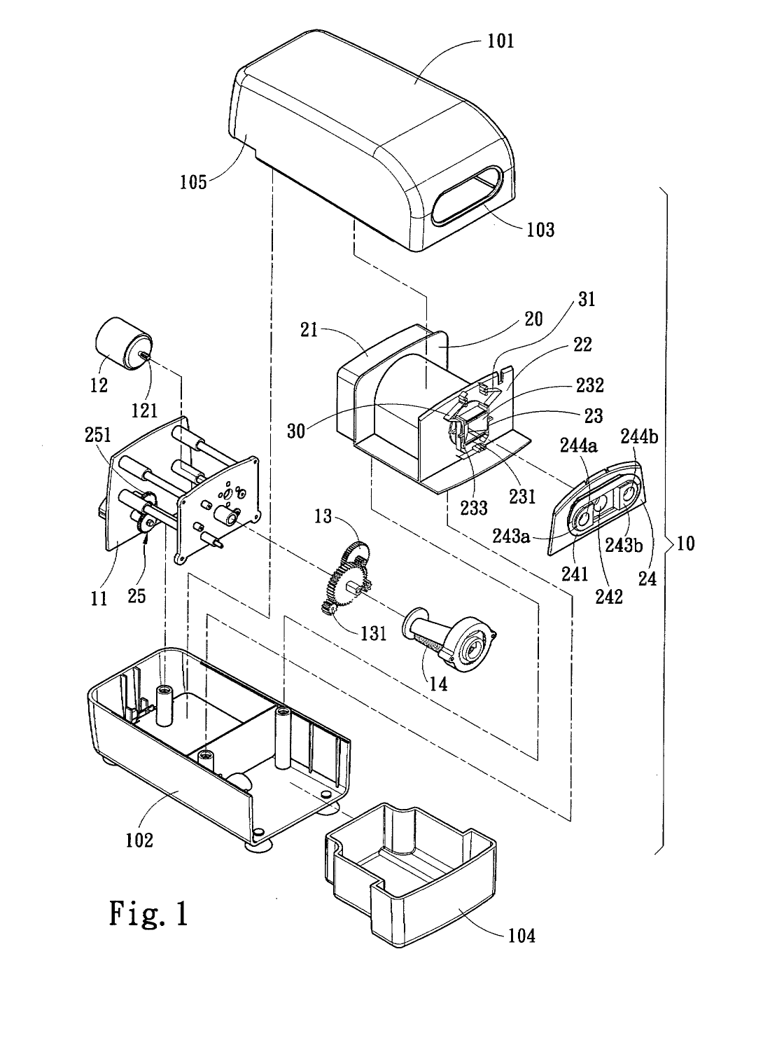

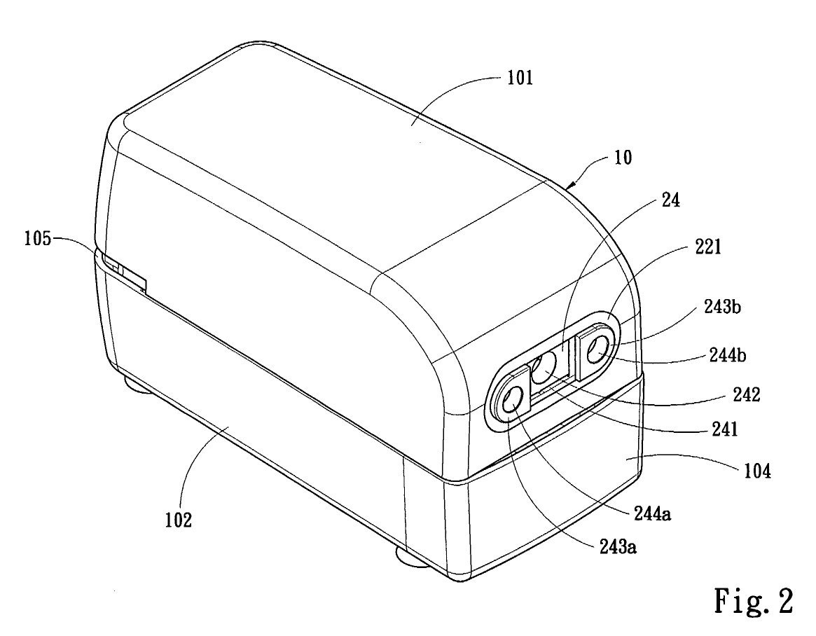

Referring to FIGS. 1 and 2, an automatic pencil sharpener of the invention comprises the following elements:

A rectangular hollow box 10 includes an upper box 101 and a lower box 102 engaged with each other, and the upper box 101 has a rectangular window 103 disposed at the front of the upper box 101, and the front of the bottom of the lower box 102 is wide open for receiving a pencil shavings box 104.

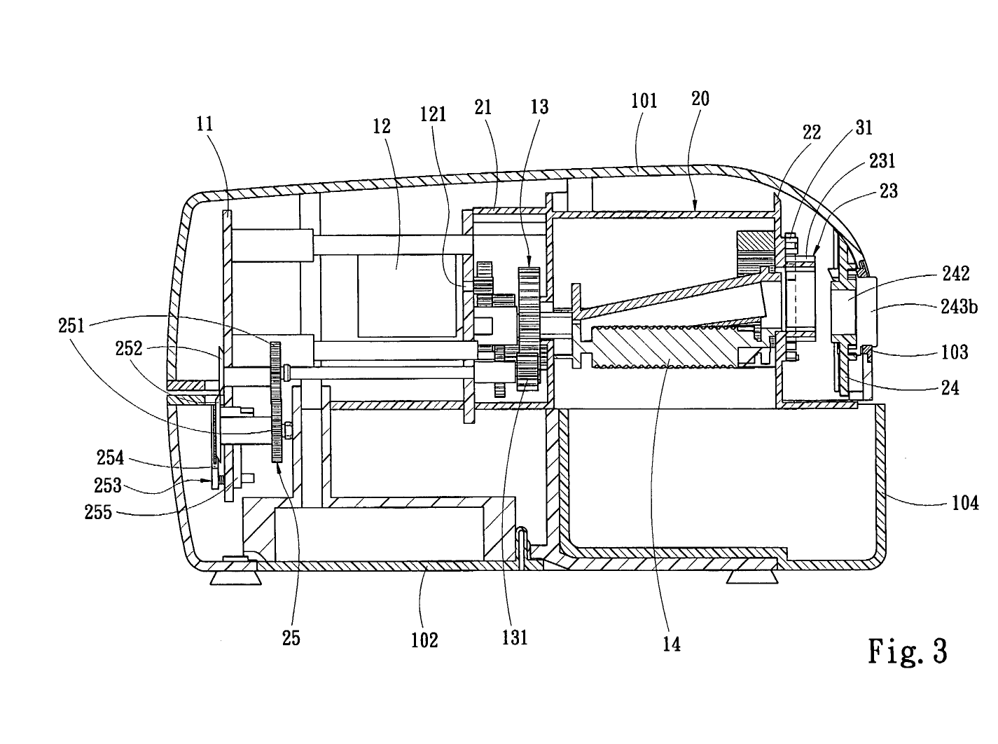

A rack 11 as shown in FIG. 3 is installed at the rear in the box 10, and the rack 11 at its middle has a driving source 12 (such as a motor), and a driving axle 121 is protruded from the front of the driving source 12 for lining a retarded gear set 13, and the gear set 13 is connected to a rolling blade 14 for driving the rolling blade 14 to rotate, and the pencil shavings box 104 is situated under the rolling blade 14.

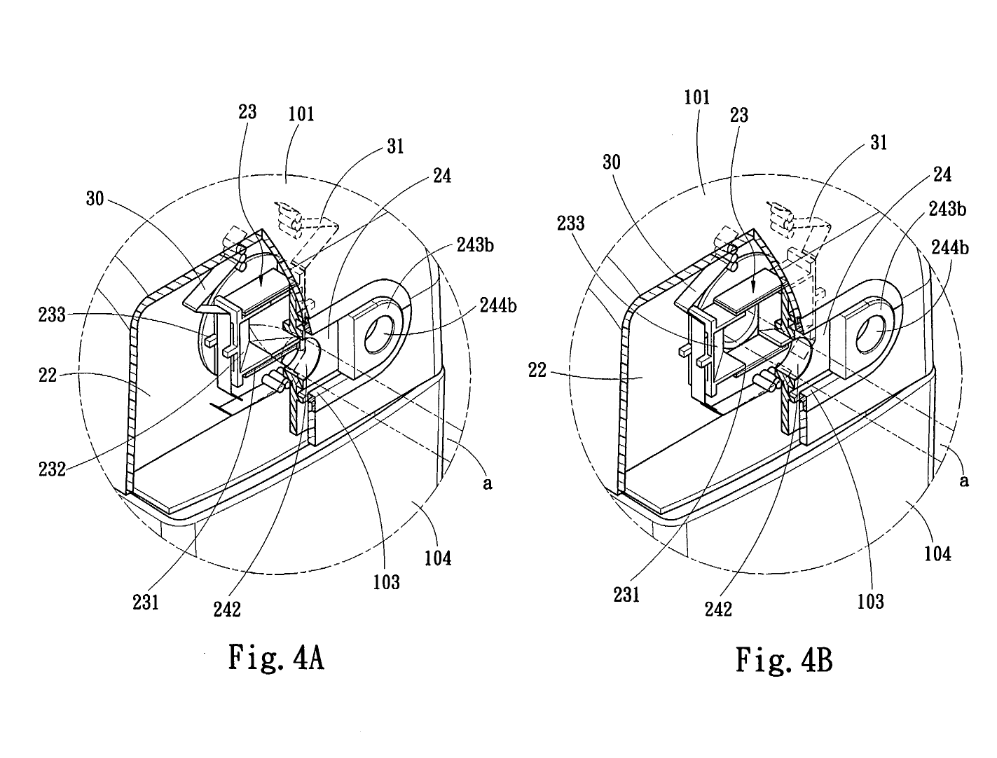

A chamber 20 having a hook with an opening facing downward is situated at the front section in the box 10, and the chamber 20 has a gear box 21 disposed at a rear side, and the gear set 13 at the front of the driving source 12 is situated in the gear box 21, and the internal space at the front of the chamber 20 is provided for covering the rolling blade 14, and a panel 22 is disposed at the front of the chamber 20, and a trigger 23 is disposed at the front of the panel 22 as shown in FIGS. 4A and 4B. The trigger 23 further includes a rectangular containing box 231, a pair of trigger members 233 disposed on both left and right sides of the containing box 231 and capable of being shifted inward or outward, and a wedge-shape space 232 defined in the middle of the two trigger members 233 and interconnected to the interior of the chamber 20.

A detecting apparatus 30 includes a pair of bent and folded sensor plates 31 disposed at the external side of the trigger member 233, such that if a pencil is inserted into the wedge-shape space 232, the two trigger members 233 will be moved outward to send a signal to the driving source 12 and start the driving source 12 to rotate a rolling blade 14. After the pencil is sharpened, the sensor plate 31 will send a signal to the driving source 12 to stop the rotation of the driving source 12 for removing the pencil.

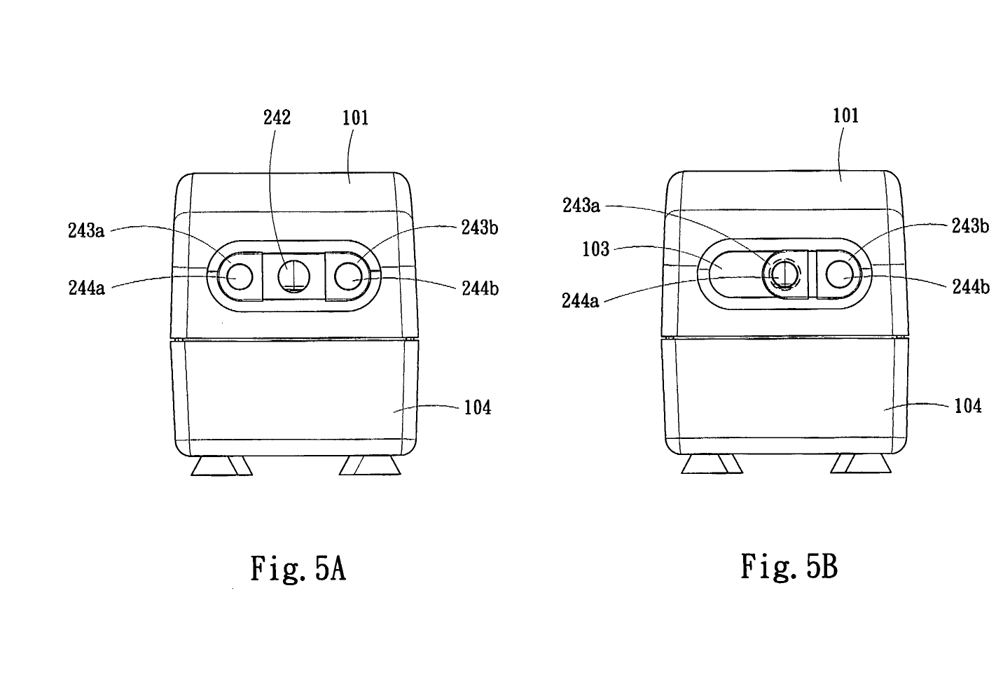

A fixing plate 24 is installed on an internal wall at the front of the upper box 101 and corresponding to the window 103, and a transversal rectangular concave edge 241 is disposed at the front of the fixing plate 24 and having an insert hole 242 at the middle of the concave edge 241 for receiving the insertion of a pencil, and the insert hole 242 is in a circular shape, and both left and right sides of the concave edge 241 have a separate slide member 243a, 243b, and each slide member 243a, 243b includes an insert hole 244a, 244b, and the two insert holes 244a, 244b of the slide members 243a, 243b are of different diameters as shown in FIG. 5A and smaller than the diameter of the insert hole 242 such that when a slide member 243a, 243b is moved to the middle of the concave edge 241, it corresponds to the insert hole 242 as shown in FIG. 5B for positioning and engaging the pencils of different diameters.

The center of the insert hole 242 at the middle of the concave edge 241 of the fixing plate 24 defines an angle with respect to the center of the rolling blade 14 as shown in FIG. 3, so that after the pencil is inserted into the insert hole 24, the rolling blade 14 can shave the tip of the pencil into a conic shape.

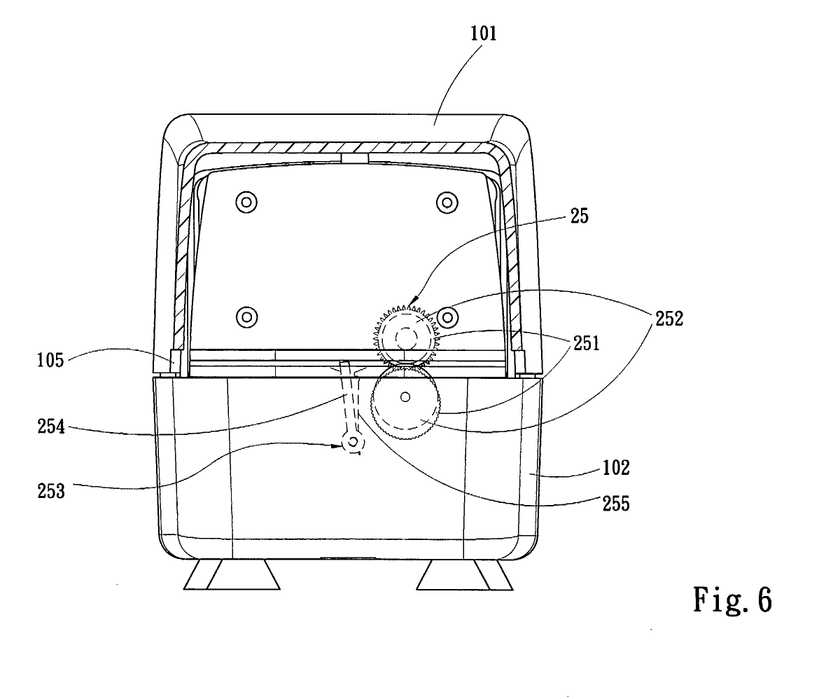

Referring to FIGS. 1, 2, 3 and 6, a breach 105 disposed at the rear side of the box 10 includes a letter opening mechanism 25 therein, and the letter opening mechanism 25 includes a pair of upper and lower gears 251 and a sensor 253. The pair of gears 251 is pivotally coupled to the rear wall of the rack 11, and each gear 251 has two circular blades 252 disposed at the rear side of the gear 251, and the two blades 252 correspond to each other vertically. The upper gear 251 is coaxial with a small gear 131 at the bottom of the gear set 13. The sensor 253 is situated on a side of the gear 251 for sending a signal to the driving source 12. The sensor 253 includes a pivotal connecting rod 254 pivotally coupled to the rear wall of the rack 11 for swaying the pivotal connecting rod 254 and a V-shaped sensor plate 255 situated at the front of the pivotal connecting rod 254. If an envelope is inserted from the breach 105 in a direction towards the two blades 252, an upper portion of the pivotal connecting rod 254 is triggered to move to the right side, and then the right side of the sensor plate 255 is triggered, and the sensor plate 255 can link the driving source 12 to start the driving source 12 and drive the small gear 131 to rotate, such that the two gears 25 are rotated to drive the two blades 252 to rotate and cut the envelope. After the envelope is cut, the pivotal connecting rod 254 resumes its position to trigger the left side of the sensor plate 255 and send a signal to the driving source, so as to stop the rotation of the two blades 252.

With the foregoing structure, a signal will be sent to the driving source 12 to start the rolling blade 14 to rotate and shave the pencil, if a pencil is inserted into an insert hole 242 at the middle of the fixing plate 24 from the upper box 101, and the pencil is in touch with the trigger member 233 disposed on both left and right sides of the trigger 23. The detecting apparatus 30 in the insert hole 242 will send a signal to the driving source 12 to stop the operation after the pencil is sharpened and indicate that the pencil is sharpened, and then the pencil can be removed.

It is noteworthy to point out that a pencil with a large diameter can be inserted into an insert hole 242 with a larger diameter of the fixing plate 24 for sharpening the pencil. Two slide members 243a, 243b disposed on both left and right sides of the fixing plate 24 at the front of the upper box 101 can be shifted sideway to fit pencils with smaller diameters into insert holes 244a, 244b to overcome the shaking problem when pencils of smaller diameter are sharpened.

Further, the present invention also provides a function for opening letters. When a letter is opened, an envelope is inserted from a side of the breach 105 at the rear side of the box 10, and then a sensor 253 of the letter opening mechanism 25 detects the letter to start driving source 12 to rotate two upper and lower circular blades 252, so as to cut an edge of the envelope and achieve the effect of opening a letter.

In summation of the description above, the patent specification and its related drawings have been applied for manufacturing and producing samples that have been passed many tests and used for many times, and such samples can achieve the expected purposes and performances, and thus the invention is useful in the industry and complies with the patent application requirements, and duly filed for patent application.

What is claimed is:

1. An automatic pencil sharpener, comprising:
a hollow box, having a rectangular window disposed at the front side of said box, and the front side of the bottom of said window being wide open for receiving a pencil shavings box;
a rack, disposed at the rear inside said box, and the front of said rack having a driving source, and the front of said driving source having a driving axle linked to a gear set for driving a rolling blade to rotate;
a chamber, covered on said gear set and said rolling blade, and having a panel disposed at the front of said chamber;
a trigger, disposed at the front of said panel of said chamber, and having a rectangular containing box, and said containing box having a pair of trigger members disposed respectively on both left and right sides of said containing box and can be moved sideway, and a wedge-shape space being formed between said pair of trigger members, and said wedge-shape space being interconnected to said chamber, and said pair of trigger members sending a signal to said driving source, for starting to rotate said rolling blade;
a detecting apparatus, having a pair of bent and folded sensor plates, and said each sensor plate being disposed on an external side of said trigger member for sending a signal to said driving source, for stopping said driving source;
a fixing plate, disposed at the rear of said window of said box, and having a circular insert hole disposed at the middle of said fixing plate, and the center of said insert hole constituting an angle with respect to said rolling blade.

2. The automatic pencil sharpener of claim 1, wherein said box is in a rectangular shape and comprised of an upper box and a lower box engaged with each other, and said pencil shavings box is installed at the front of said lower box and disposed under said rolling blade.

3. The automatic pencil sharpener of claim 1, wherein said box has a breach disposed at the rear of said box, and a letter opening mechanism installed in said breach, and said letter opening mechanism comprises a pair of upper and lower gears and a sensor, and said pair of gears are pivotally coupled to the rear of said rack, and said each gear has two circular blades disposed at the rear of said gear and vertically corresponding to each other, and said gear set further comprises a small gear disposed thereunder, and said gear above said letter opening mechanism is coaxial with said small gear of said gear set, and said sensor is disposed on a side of said two blades and includes a pivotal connecting rod pivotally coupled to the rear of said rack and a V-shaped sensor plate, and an upper end of said pivotal connecting rod is in contact with both left and right sides of said sensor plate.

4. The automatic pencil sharpener of claim 1, wherein said fixing plate has a transversal rectangular concave edge disposed at the front of said fixing plate, and said insert hole is disposed at the middle of said concave edge, and said two slide members capable of moving sideway are disposed on both sides of said concave edge, and said each slide member has another insert hole disposed at the middle of said slide member, such that the diameters of said insert holes of said two slide member are different and smaller than said insert hole at the middle of said fixing plate.
